(19) United States
(12) Patent Application Publication
(10) Pub. No.: US 2023/0179843 A1
(43) Pub. Date: Jun. 8, 2023

(54) Aperture Stop Exploitation Camera

(71) Applicant: Utah State University Space Dynamics Laboratory, North Logan, UT (US)

(72) Inventor: Aaron Pung, Albuquerque, NM (US)

(73) Assignee: Utah State University Space Dynamics Laboratory, North Logan, UT (US)

(21) Appl. No.: 17/954,446

(22) Filed: Sep. 28, 2022

Related U.S. Application Data
(63) Continuation-in-part of application No. 17/540,327, filed on Dec. 2, 2021.

(51) Int. Cl. H04N 5/225; G03B 17/17

(52) U.S. Cl. CPC H04N 5/2258; G03B 17/17

(57) ABSTRACT

An aperture stop exploitation camera comprises an imaging lens column positioned along an optical axis and configured to transmit light from a scene from a single viewpoint and converge the light as it passes through the aperture stop. Also, the camera comprises a light redistribution optic (LRO) that is a thin V-shape having an apex. The LRO is centered along the optical axis with the apex pointing towards the imaging lens column. The LRO has two planar sides with each side angled 45 degrees with respect to the optical axis and each side configured to reflect and transmit the light transmitted from the imaging lens column into three independent, spatially separate images, each retaining all the spectral, polarimetric, and relative intensity information of the light from the scene. The camera comprises three image sensors, each image sensor positioned to receive one of the three independent, spatially separate images.

### CROSS-REFERENCE TO RELATED APPLICATIONS

This application is a continuation-in-part to U.S. Non-provisional application Ser. No. 17/540,327, filed on Dec. 2, 2021, and entitled “Uniaxial Optical Multi-Measurement Sensor,” which is incorporated by this reference in its entirety.

### TECHNICAL FIELD

The present disclosure relates to measuring properties of light from a scene, and more particularly, to novel systems and methods for measuring up to multiple properties of light from a single camera.

### BACKGROUND

Conventional digital cameras utilize an optical lens column to capture, transport, and focus light from a scene onto photo-sensitive CCD (charge-coupled device) or CMOS (complementary metal oxide semiconductor) sensors. In color detectors, the pixels are often arranged in a three-color Bayer pattern; light absorbed by the red, green, and blue (RGB) pixels undergoes a process to demosaic the color channels and produce a single image. In turn, objects and materials within each image can be identified and separated during post-processing with spectral indexing and edge-finding techniques.

To complement developments in post-processing, recent research efforts have focused on enhancing the capabilities of the imaging system. Adding a linear polarizer in front of the lens column, for example, improves image contrast by reducing glare and reflections from non-metallic surfaces.

Furthermore, images taken with the polarization filter rotated to 0, 45, 90, and 135 degrees allow the first three Stokes parameters (S₀, S₁, and S₂) to be calculated. In turn, the degree of linear polarization (DoLP) and angle of linear polarization (AoLP) can be derived to provide highly detailed measurements of surface characteristics, albedo, and illumination within the scene.

Moreover, the four linear polarizer orientations can be combined into a single polarization filter array (PFA) and placed within the optical system as a divided aperture or divided focal plane. Furthermore, each polarization filter can be combined with a unique spectral filter. Although great care must be taken to properly calibrate the camera system and properly demosaic the resulting data, both the results and their redundancies can be exploited to fully characterize the scene.

### SUMMARY

The inventor of the embodiments described in this disclosure has identified that each of these solutions described above is found to be lacking. The disadvantage of these approaches lies in the position of the filter component, since any filter placed along the optical axis imposes its functionality on the resulting image. To alleviate this issue, alternative methods have been developed to generate multiple images from the single input scene. Much like multispectral snapshot cameras, images split using prisms, X-cubes, compound optics, and beam splitters can be recombined and analyzed during post-processing.

In the case of color polarization filter arrays, spectral and polarimetric data can be extracted during post-processing, but the camera only ever collects one image. In cases where an additional unfiltered baseline image is desired or overall data collection would benefit from capturing data sets separately, capturing a single image within the camera system is not optimal. In systems which spectrally or polarimetrically split the incident scene, none of the resulting images independently contain all spectral, polarimetric, and relative intensity data from the scene. Lastly, the pyramid prism array imaging system manages to generate multiple images in a way that preserves spectral information, but the reduced size of the resulting images ultimately limits the camera's resolution.

Embodiments of the present disclosure present an alternative approach to overcome the limitations in each of the previous systems. A proposed aperture stop exploitation camera (ASTEC) system places a reflective component along the optical axis to exploit properties of the aperture stop. Depending on the location and geometry of the new component, incoming light rays may be split into three independent spatially separated images, in which each image retains all spectral, polarimetric, and relative intensity information of the original scene.

In embodiments, an aperture stop exploitation camera comprises an imaging lens column positioned along an optical axis and configured to transmit light from a scene from a single viewpoint and converge the light as it passes through the aperture stop. Also, the camera comprises a light redistribution optic (LRO) that is a thin V-shape having an apex. The LRO is centered along the optical axis with the apex pointing towards the imaging lens column. The LRO has two planar sides with each side angled 45 degrees with respect to the optical axis and each side configured to reflect and transmit the light transmitted from the imaging lens column into three independent, spatially separate images. Each image retains all the spectral, polarimetric, and relative intensity information of the light from the scene. Finally, in embodiments, the camera comprises three image sensors, each image sensor positioned to receive one of the three independent, spatially separate images.

In another embodiment of the aperture stop exploitation camera, the LRO is placed near the plane of the aperture stop and the width and height of the LRO do not exceed a diameter of the largest lens in the imaging lens column.

In another embodiment of the aperture stop exploitation camera, a first of the three independent, spatially separate images is reflected from the LRO onto a first of the three image sensors; a second of the three independent, spatially separate images is reflected from the LRO onto a second of the three image sensors; and a third of the three independent, spatially separate images is transmitted through the LRO onto a third of the three image sensors. Also, the first, second, and third of the three independent, spatially separate images each contain a full view of the scene.

In another embodiment of the aperture stop exploitation camera, the thin V-shape has a front side and a back side, the front side faces the imaging lens column and the back side faces away from the imaging lens column. A first, front side of the two planar sides is coated with a broadband non-polarizing 50% reflective coating (R_{c}=50%) such that the first, front side reflects 25% of the light from the scene to the first of the three image sensors. Also, a first, back side, being opposite the first, front side, is coated with a broadband anti-reflection coating such that the first, back side of the two planar sides transmits 25% of the light from the scene towards the third of the three image sensors. A second, front side of the two planar sides is coated with a broadband non-polarizing 50% reflective coating (R_{c}=50%) such that the second, front side reflects 25% of the light from the scene to the second of the three image sensors. A second, back side, being opposite the second, front side, is coated with a broadband anti-reflection coating such that the second, back side of the two planar sides transmits 25% of the light from the scene to the third of the three image sensors. Finally, the first and second of the three image sensors each receive 25% of the light from the scene and the third of the three image sensors receives 50% of the light transmitted from the scene.

In another embodiment of the aperture stop exploitation camera, the thin V-shape has a front side and a back side, the front side faces the imaging lens column and the back side faces away from the imaging lens column. A first, front side of the two planar sides is coated with a broadband non-polarizing 66.67% reflective coating (R_{c}=66.67%) such that the first, front side reflects 33.33% of the light from the scene to the first of the three image sensors. A first, back side, being opposite the first, front side, is coated with a broadband anti-reflection coating such that the first, back side of the two planar sides transmits 16.67% of the light from the scene to the third of the three image sensors. Also, a second, front side of the two planar sides is coated with a broadband non-polarizing 66.67% reflective coating (R_{c}=66.67%) such that the second, front side reflects 33.33% of the light from the scene to the second of the three image sensors. A second, back side, being opposite the second, front side, is coated with a broadband anti-reflection coating such that the second, back side of the two planar sides transmits 16.67% of the light from the scene to the third of the three image sensors. In this embodiment, each of the first, second, and third image sensors each receive 33.33% of the light from the scene.

In another embodiment of the aperture stop exploitation camera, the thin V-shape has a front side and a back side, the front side faces the imaging lens column and the back side faces away from the imaging lens column. A first, front side of the two planar sides is configured to reflect ultra-violet (UV) light such that the front side reflects UV light from the scene to the first of the three image sensors. Additionally, a second, front side of the two planar sides is configured to reflect infrared (IR) light such that the second, front side reflects IR light from the scene to the second of the three image sensors. Similarly, a first, back side, being opposite the first, front side, and a second, back side, being opposite the second, front side, are both configured to transmit visible light from the scene to the third of the three image sensors. Finally, the first of the three image sensors receives UV light from the scene, the first of the three imaging sensors being a UV sensor; the second of the three image sensors receives IR light from the scene, the second of the three imaging sensors being an IR sensor; and the third of the three image sensors receives visible light from the scene, the third of the three imaging sensors being a visible-light sensor.

In another embodiment of the aperture stop exploitation camera, the thin V-shape has a front side and a back side, the front side faces the imaging lens column and the back side faces away from the imaging lens column. A first, front side of the two planar sides is configured to reflect horizontally polarized light such that the first, front side reflects a first front-side polarized light to the first of the three image sensors; the first, front-side polarized light is horizontally polarized. Similarly, a first, back side, being opposite the first, front side, is configured to transmit vertically polarized light such that the first, back side transmits a first, back-side polarized light towards the third of the three image sensors; the first back-side polarized light is vertically polarized. Additionally, a second, front side of the two planar sides is configured to reflect vertically polarized light such that the second, front side reflects a second, front-side polarized light from the scene to the second of the three image sensors; the second, front-side polarized light is vertically polarized. Also, a second, back side, being opposite the second, front side, is configured to transmit horizontally polarized light such that the second, back side of the two planar sides transmits a second, back-side polarized light from the scene towards the third of the three image sensors; the second back-side polarized light being horizontally polarized. Finally, the aperture stop exploitation camera further comprises a transmissive polarizer with its transmission axis rotated around the optical axis at 45 degrees with respect to an axis perpendicular to the optical axis. The transmissive polarizer is configured to receive and transmit the first, back-side polarized light and the second back-side polarized light.

Embodiments of the present disclosure also include methods for measuring or imaging from a single viewpoint two or more properties of light entering a sensor system from a single scene.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a prior-art example of a Double Gauss lens arrangement;

FIG. 2 is a prior-art example of a Petzval lens arrangement with at field flattener;

FIG. 3 is a prior-art example of a Wide-Angle Inverted Telephoto lens arrangement;

FIG. 4. is an aperture stop exploitation camera according to embodiments of the present disclosure;

FIG. 5 is a close-up view of part of the aperture stop exploitation camera illustrated in FIG. 4;

FIG. 6 is another close-up view of a different embodiment of part of the aperture stop exploitation camera illustrated in FIG. 4;

FIG. 7 is another illustration of an embodiment of the present disclosure;

FIG. 8A is an input image;

FIGS. 8B and 8C are images reflected from a light redistribution optic according to embodiments of the present disclosure;

FIG. 8D is a transmitted image from a light redistribution optic according to embodiments of the present disclosure;

FIG. 9 is a graph illustrating the transmitted and reflected wavelengths of light through example optical coatings that may be applied to a light redistribution optic according to embodiments of the present disclosure; and

FIG. 10 is an example process of measuring or imaging from a single viewpoint two or more properties of light according to embodiments of the present disclosure.

### DETAILED DESCRIPTION

The present disclosure covers apparatuses and associated methods for an aperture stop exploitation camera. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally” or “or” refer, for example, to instances in which subsequently described circumstance may or may not occur, and include instances in which the circumstance occurs and instances in which the circumstance does not occur. For example, if the text reads “option A or option B,” there may be instances where option A and option B are mutually exclusive or instances where both option A and option B may be included. The terms “one or more” and “at least one” refer, for example, to instances in which one of the subsequently described circumstances occurs, and to instances in which more than one of the subsequently described circumstances occurs.

### Common Camera Lens Systems

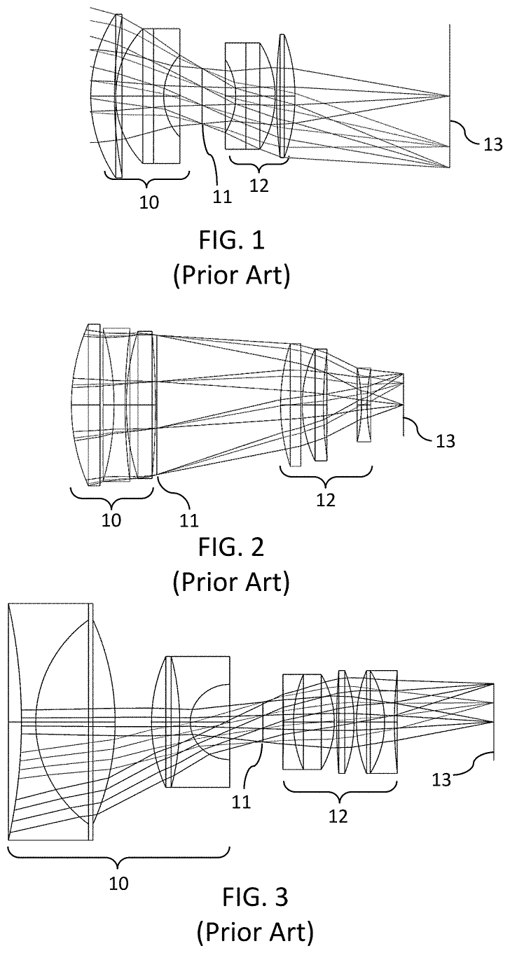

From digital single-lens reflex (DSLR) to smartphone cameras, the size and configuration of a camera's lens system varies greatly based on its application and allowable footprint. Despite their differences, however, many camera systems share fundamental similarities in their design. For instance, while the layout of the simple imaging systems illustrated in FIGS. 1, 2, and 3 significantly differ from other modern lens systems like DSLR retrofocus lenses or modern aspherical mirror-less camera lenses, each shares a front set of lenses 10, an aperture stop 11, a rear set of lenses 12, and an image sensor 13. FIG. 1 illustrates a Double Gauss lens arrangement. FIG. 2 illustrates a Petzval lens arrangement with a field flattener. FIG. 3 illustrates a Wide-Angle Inverted Telephoto lens arrangement. FIGS. 1, 2, and 3 also illustrate simulated light ray traces emitted from a scene (not shown) through the front set of lenses 10, the aperture stop 11, and then through rear set of lenses 12, and onto an image sensor 13.

Embodiments of the present disclosure can work with the modification to the lens arrangements illustrated in FIGS. 1 and 2 but not the lens arrangement illustrated in FIG. 3. In FIGS. 1 and 2, the light rays are converging as they pass through the aperture stop 11. This not the case for the light rays illustrated in FIG. 3. Instead, in FIG. 3, the light rays are not converging as they pass through the aperture stop 11. Embodiments of the present invention can work with lens arrangements where light is converging as it passes through an aperture stop but not in lens arrangements where light is not converging as it passes through the aperture stop.

Embodiments of the present disclosure can work with other lens arrangements that include similar features of a front set of lenses, an aperture stop where light is converging as it passes through the aperture stop, a rear set of lenses, and an image sensor. These include the Petzval Objective, Tessar, Bertele Wide-Angle, Cooke Triplet, Inverted Telephoto, and Meniscus Anastigmat lens arrangements, etc.

### The Aperture Stop

The location of the aperture stop is significant for two reasons. First, the plane of the aperture stop is the only location along the optical axis where each ray bundle from the scene lies concentrically along the optical axis. Second, in some optical systems, it is the narrowest point within the optical system containing all ray bundles to be imaged on the sensor, making it an ideal location to place a spatially compact division-of-aperture filter. Although not always the case, light rays passing through an aperture stop in some imaging systems have already begun to converge; this is true for geometries like the classical mirrorless camera lens and Petzval lens arrangement with a field flattener, but not for wide-angle inverted telephoto lenses. While the resulting images may not be ideal, this means that light passing through the aperture stop would still form an image on a detector even if the rear set of lenses were not present.

### The Light Redistribution Optic

In embodiments of the present disclosure, to exploit the features of the aperture stop, a light redistribution optic (LRO) was designed to split the incident light into two reflected images and one transmitted image such that each image contains the full view of the scene and all spectral and polarimetric information is retained. For simplicity, the initial LRO geometry was designed to be used with a basic imaging system whose light rays converge as they pass through the aperture stop. The example optical system used in embodiments of the present disclosure is the Double Gauss Experimental Arrangement.

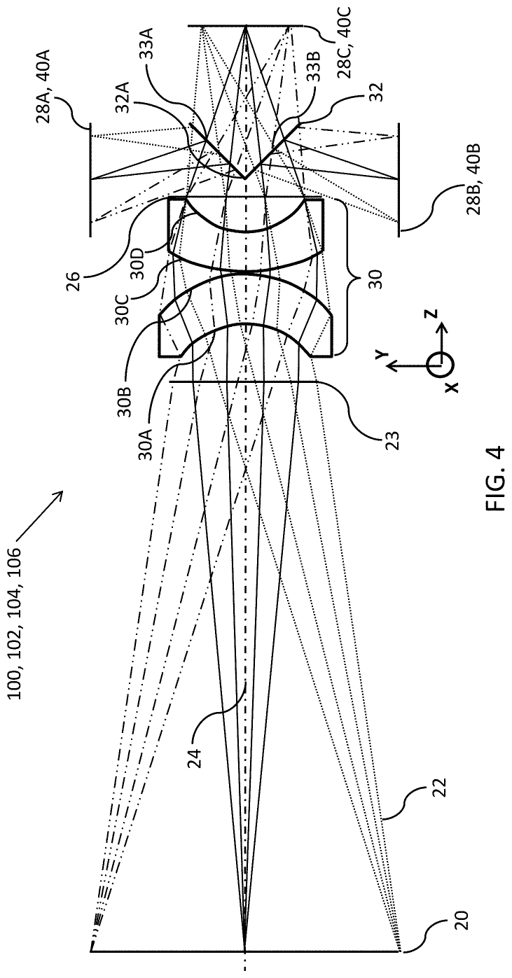

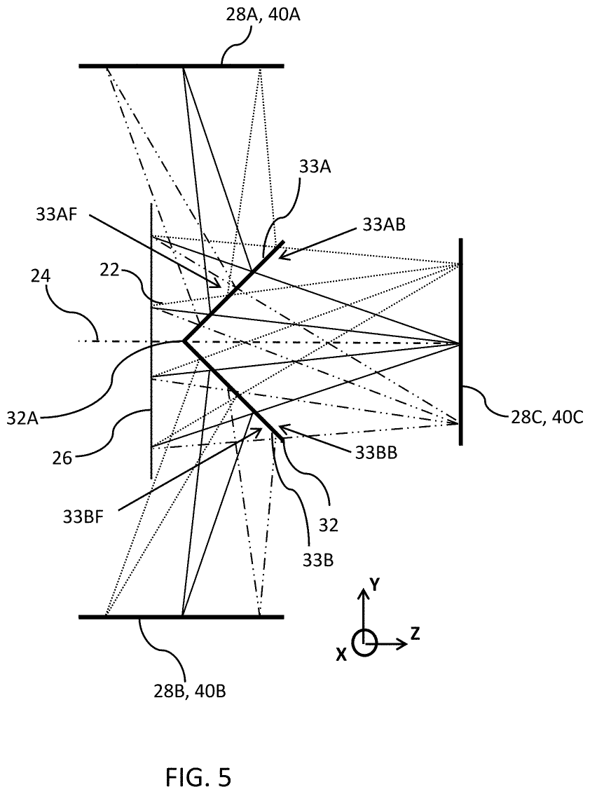

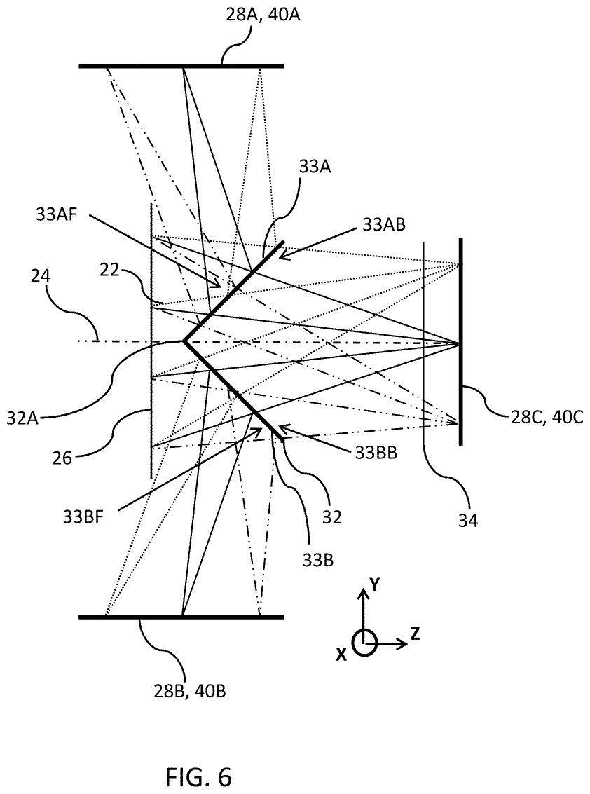

FIG. 4 illustrates an aperture stop exploitation camera 100. FIGS. 5 and 6 illustrate close-up views of the “aft” end of different embodiments of the present disclosure. In FIGS. 5 and 6, the ray traces of the light 22 are reproduced between the aperture stop 26 and the image sensors 40A, 40B, and 40C.

In this example, aperture stop exploitation camera 100 is adapted from a Double Gauss lens arrangement but includes a light redistribution optic according to embodiments of the present disclosure.

In embodiments, the geometry of the LRO 32 takes the form of a thin V-shaped reflective component whose apex 32A points towards the imaging lens column 30 or towards the scene 20 (−Z direction in FIG. 4) and has elongated edges aligned parallel to the X-axis. The top, front 33AF and bottom, front 33BF surfaces of the LRO 32 form a right angle, and each surface sits at a 45-degree angle to the optical axis.

In embodiments, the substrate of the LRO 32 consists of Schott FK3 glass, and the forward-facing (−Z) surfaces 33AF and 33BF (shown in FIG. 5) support a broadband non-polarizing 50% reflective coating. In some examples, to eliminate internal reflections, the back-facing (+Z) surfaces or back sides 33AB and 33BB of the LRO 32 is coated with a broadband anti-reflection coating. The LRO 32 is placed near the plane of the aperture stop 26. The LRO 32 width and height need not exceed the diameter of the largest lens in the array 30. In this configuration, the LRO 32 splits the incident light 22 into three independent and spatially separated images 28A, 28B, and 28C. The top 33AF (+Y) and bottom 33BF (−Y) LRO 32 surfaces reflect light 22 from the incident scene 20 toward first and second sensors 40A and 40B, respectively, while the transmitted image 28C continues along the optical axis (+Z) towards the third sensor 40C. Furthermore, the convergence of the light rays 22 prior to reaching the aperture stop 26 suggests the rear lens array can be removed entirely as shown in FIG. 4. Left untouched, the front lens array 30 continues to produce highly detailed images (e.g., images 28A, 28B, and 28C), but the images may contain distortion, astigmatism, or field curvature. As discussed later, these aberrations can be corrected by optimizing parameters of a remaining lens column.

### Example Embodiments of an Aperture Stop Exploitation Camera

In FIG. 4, light, illustrated as light ray traces 22, from a scene 20, enters the aperture stop exploitation camera 100. Note that the light ray traces include the various dashed lines emanating from the scene 20. In addition, the light or light ray traces 22 pass through a paraxial lens 23, which is a surface that acts like an ideal thin lens, configured such that light 22 from any point in the scene 20 would pass through the paraxial lens 23 and come together at a single point in the image (e.g., images 28A, 28B, or 28C), devoid of any aberrations.

In embodiments, an aperture stop exploitation camera 100 comprises an imaging lens column 30 positioned along an optical axis 24. The imaging lens column 30 is configured to transmit the light 22 from the scene 20 from a single viewpoint and converge the light 22 as it passes through the aperture stop 26.

The aperture stop exploitation camera 100 further includes a light redistribution optic (LRO) 32 that is a thin V-shape having an apex 32A. The LRO 32 is centered along the optical axis 24 with the apex 32A pointing towards the imaging lens column 30 or towards the scene 20. The LRO 32 is positioned at the aperture stop 26. “At the aperture stop 26” means the apex 32A of LRO 32 is placed as closely to (the plane of) the aperture stop 26 as possible because the aperture stop 26 is the location where all the light 22 is centered on the optical axis 24 and where light rays 22 from the scene 20 overlap concentrically. Note that in FIG. 4 the LRO 32 is illustrated as being slightly behind the aperture stop 26 because light 22 reflected off LRO 32 must avoid striking the aft-most lens (not labeled) of the imaging lens column 30. In this sense, the apex 32A of LRO 32 (or LRO 32) is still positioned “at the aperture stop 26” because the LRO 32 is placed as closely to the aperture stop 26 as possible.

The LRO 32 has two planar sides: first LRO planar side 33A and second LRO planar side 33B. Each side 33A and 33B is angled 45 degrees with respect to the optical axis 24. Also, each side 33A and 33B are configured to reflect and transmit the light 22 transmitted from the imaging lens column 30 into three independent, spatially separate images: first independent, spatially separate image 28A, second independent, spatially separate image 28B, and third independent, spatially separate image 28C. In embodiments, each image 28A, 28B, and 28C retain all the spectral, polarimetric, and relative intensity information of the light 22 from the scene 20.

The aperture stop exploitation camera 100 further includes three image sensors 40A, 40B, and 40C. In addition, each image sensor 40A, 40B, and 40C are positioned to receive one of the three independent, spatially separate images 28A, 28B, or 28C.

Embodiments of the present disclosure may not include a rear set of lenses 12 illustrated in FIGS. 1, 2, and 3. For example, in FIG. 4, there is not a set of lenses placed between the LRO 32 and the image sensors 40A, 40B, and 40C. Instead, these lenses may be removed from embodiments because the light 22 is converging at (the plane of) the aperture stop 26. The removal of the rear set of lenses, e.g., lenses 12 in FIGS. 1, 2, and 3, can be a significant advantage as it may reduce the weight, size, cost, and complexity of the aperture stop exploitation camera.

The design of the LRO 32 may be simple, intuitive, modular, and lightweight. However, the success of its implementation relies heavily on the geometry of its surfaces. The 45-degree angle of the LRO 32 surfaces 33AF and 33BF is chosen intentionally to redirect the incident light rays 22 in a direction generally orthogonal to the optical axis 24. If the LRO 32 surfaces' 33AF and 33BF angle is changed significantly, the focal plane of the reflected rays may become stretched along the Z-axis resulting in blurry and elongated images. Furthermore, the resulting images 28A and 28B may be laterally shifted along the Z-axis due to the new angle of incidence between the light rays exiting the front lens array 30 and the LRO 32 surfaces 33AF and 33BF. Similarly, the choice of planar LRO 32 faces 33AF and 33BF is also intentional and allows the already convergent light rays 22 to converge and focus on their intended sensor. Reflections from non-planar surfaces, on the other hand, would exacerbate an image's astigmatism or cause some rays 22 to not converge at all, resulting in a severe reduction in image quality.

In another embodiment, and as illustrated in FIG. 4, the width and height of the LRO 32 is smaller than the diameter of the largest lens in the imaging lens column 30.

In another embodiment, the first independent, spatially separate image 28A, is reflected from the LRO 32 onto a first image sensor 40A. Similarly, a second independent, spatially separate image 28B is reflected from the LRO 32 onto a second image sensor 40B. Finally, a third independent, spatially separate image 28C is transmitted through the LRO 32 onto the third image sensor 40C. In this embodiment, the first 28A, second 28B, and third 28C independent, spatially separate images each contain a full view of the scene 20.

The reflected 28A, 28B, and transmitted 28C images are heavily influenced by the optical coatings or grating applied to the LRO 32. Note that a coating or grating may be applied to any surface of the LRO 32 to achieve a desired effect, e.g., coatings and gratings may be interchangeable. Applying the same coating or grating to both reflective surfaces 33AF and 33BF ensures the top and bottom halves of the transmitted image 28C are identically filtered, but applying different coatings or gratings to the reflective surfaces 33AF and 33BF can greatly increase the filtering capabilities of the aperture stop exploitation camera 100. For instance, applying a broadband non-polarizing 50% reflection coating to each forward-facing surface 33AF and 33BF of the LRO 32 results in three independent, spatially separated images 28A, 28B, and 28C, each of which contains the full scene 20 with all spectral, polarimetric, and relative intensity information. In this case, the process of collecting and analyzing the incoming light 22 is divided across three sensors 40A, 40B, and 40C, instead of one, and each image 28A, 28B, and 28C can be independently and uniquely filtered or processed using custom sensor arrays, clip filters, post-processing algorithms, or some combination thereof.

Referring now to FIGS. 4 and 5, in embodiments, the thin V-shape of the LRO 32 has two front sides: first front side 33AF and second front side 33BF. LRO 32 also has two back sides: first, back side 33AB and second, back side 33BB; the back sides 33AB and 33BB are opposite their respective front sides 33AF and 33BF. The first and second front sides 33AF and 33BF face the imaging lens column 30 (not shown in FIGS. 5 and 6) and the first and second back sides 33AB and 33BB face away from the imaging lens column 30.

In embodiments, first, front side 33AF is coated (or covered) with a broadband non-polarizing 50% reflective coating (or grating) (R_{c}=50%), with the first front side 33AF reflecting 25% of the light from the scene 20 (not shown in FIG. 5) to the first image sensor 40A. In addition, first, back side 33AB is coated (or covered) with a broadband anti-reflection coating (or grating), the first, back side 33AB transmitting 25% of the light 22 from the scene 20 to the third image sensor 40C. Similarly, second, front side 33BF is coated (or covered) with a broadband non-polarizing 50% reflective coating (or grating) (R_{c}=50%), the second, front side 33BF reflecting 25% of the light 22 from the scene 20 (not shown in FIG. 5) to the second image sensor 40B. Finally, second, back side 33BB is coated (or covered) with a broadband anti-reflection coating (or grating), the second, back side 33BB transmitting 25% of the light 22 from the scene 20 to the third image sensor 40C.

In this arrangement, the first image sensor 40A receives 25% of the light 22 from the scene 20, the second image sensor 40B also receives 25% of the light 22 from the scene 20; the third image sensor 40C receives 50% of the light 22 transmitted from the scene 20.

Still referring to FIGS. 4 and 5, in another embodiment of an aperture stop exploitation camera 102, first, front side 33AF is coated with a broadband non-polarizing 66.67% reflective coating (R_{c}=66.67%), with the first front side 33AF reflecting 33.33% of the light 22 from the scene 20 (not shown in FIG. 5) to the first image sensor 40A. In addition, first, back side 33AB is coated with a broadband anti-reflection coating, the first, back side 33AB transmitting 16.67% of the light 22 from the scene 20 towards the third image sensor 40C. Similarly, second, front side 33BF is coated with a broadband non-polarizing 66.67% reflective coating (R_{c}=66.67%), the second, front side 33BF reflecting 33.33% of the light 22 from the scene 20 (not shown in FIG. 5) to the second image sensor 40B. Finally, second, back side 33BB is coated with a broadband anti-reflection coating, the second, back side 33BB transmitting 16.67% of the light 22 from the scene 20 towards the third 40C of the three image sensors 40A, 40B, and 40C.

In this arrangement of aperture stop exploitation camera 102, the first image sensor 40A receives 33.33% of the light 22 from the scene 20, the second image sensor 40B also receives 33.33% of the light 22 from the scene 20; and the third image sensor 40C receives 33.33% of the light 22 transmitted from the scene 20.

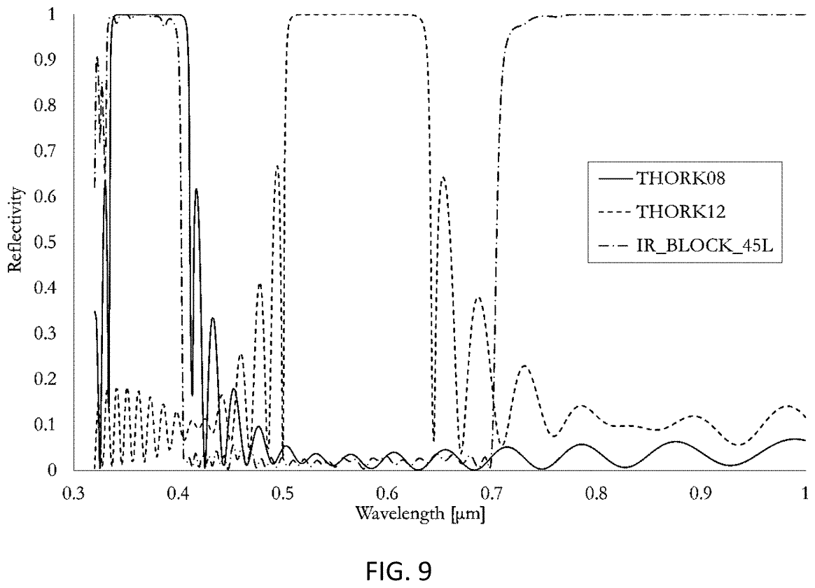

Alternatively, for an aperture stop exploitation camera 104, coating the forward LRO 32 surfaces 33AF and 33BF with different, more exotic thin films allows the aperture stop exploitation camera 104 to leverage cutting edge research in thin film design and fabrication technology. For instance, an aperture stop exploitation camera 104 utilizing calcium fluoride lenses would benefit from >90% light transmission between 0.2-8.0 μm, covering portions of the ultraviolet (UV), visible (VIS), and infrared (IR) regimes. Coating (or covering) the top LRO 32 surface 33AF with a UV-reflective film (or grating) would generate a UV image on the first sensor 40A, while coating (or covering) the bottom LRO 32 surface 33BF with an IR-reflective film (or grating) would generate an infrared image on the second sensor 40B. Two such coatings are the “THORK08” and “IR_BLOCK_45L” coatings found in the Zemax coatings database; their spectral reflectance is plotted in FIG. 9. To capture the UV and IR images, commercially available sensors like the Sony IMX487 (UV) or the Thorlabs CS135MUN NIR-Enhanced CMOS (IR) could be used. The third sensor 40C is then left to collect light from the transmitted image in the visible-light regime. In this case, however, no special detector is needed since the conventional Bayer filter used in many CCD and CMOS VIS cameras collects very little light outside of the 400-700 nm band. As with any thin-film application, attention must be paid to the film's tolerance to changes in wavelength and angle of incidence. As illustrated in FIGS. 4 and 5, light rays 22 exiting the front lens array 30 strike the LRO 32 at a variety of incidence angles. Therefore, the coating applied to the surfaces 33AF and 33BF of the LRO 32 should be tolerant to wavelength as well as variations in incidence angle. Since many thin-film designs are for beamsplitting applications, solutions satisfying these criteria are well known in the literature and are commercially available. As one example, the BSW16 50:50 Plate Beamsplitter from Thorlabs provides 50% transmission at an angle of incidence of 45 degrees across the visible regime and varies less than 10% for angle of incidence values 30 degrees from the surface normal. Despite their robustness, however, commercially available coatings continue to demonstrate some degree of polarization-dependence due to inherent material properties and the difference in optical thickness of each coating layer as seen by the different polarization states at non-normal angles of incidence.

In another embodiment of an aperture stop exploitation camera 104, a first, front side 33AF is configured to reflect ultra-violet light, the front side 33AF reflecting UV light from the scene 20 to the first image sensor 40A. In addition, a second, front side 33BF is configured to reflect IR light, the second, front side 33BF reflecting IR light from the scene 20 to the second image sensor 40B. Also, a first, back side 33AB and a second, back side 33BB are both configured to transmit visible light from the scene 20 to the third image sensor 40C. In embodiments, the first, back side 33AB and a second, back side 33BB are coated with a broadband anti-reflection coating.

In this arrangement, the first image sensor 40A receives UV light from the scene 20, the first image sensor 40A being a UV sensor. Also, the second image sensor 40B receives IR light from the scene 20, the second image sensor 40B being an IR sensor. Finally, the third image sensor 40C receives visible light from the scene 20, the third image sensor 40C being a visible-light sensor.

Referring now to FIGS. 4 and 6, in another embodiment of an aperture stop exploitation camera 106, a first, front side 33AF is configured to reflect a first, front-side polarized light that is horizontally polarized to the first 40A of the three image sensors. First, front side 33AF may be coated or covered with a wire-grid polarizer to reflect horizontally polarized light such that the first, front side 33AF reflects 25% of the light 22 from the scene 20 to the first image sensor 40A. In addition, a second, front side 33BF of the two planar sides (33AF and 33BF) is configured to reflect a second, front-side polarized light that is vertically polarized from the scene 20 to the second 40B of the three image sensors. The second, front side 33BF may be coated or covered with a wire grid polarizer to reflect vertically polarized light, such that the second, front side 33BF reflects 25% of the light 22 from the scene 20 to the second image sensor 40B. Also, a first, back side 33AB of the two planar sides (33AB and 33BB) is configured to transmit a first, back-side polarized light that is vertically polarized towards the third 40C of the three image sensors. The first, back side 33AB may be coated with a broadband anti-reflection coating, such that the first, back side 33AB transmits 25% of the light 22 from the scene 20 towards the third image sensor 40C. Likewise, a second, back side 33BB of the two planar sides (33AB and 33BB) is configured to transmit a second, back-side polarized light that is horizontally polarized towards the third 40C of the three image sensors. The second, back side 33BB may be coated with a broadband anti-reflection coating, such that the second, back side 33BB transmits 25% of the light 22 from the scene 20 towards the third image sensor 40C. Finally, the aperture stop exploitation camera 106 in this embodiment further comprises a transmissive polarizer 34 (shown in FIG. 6) with its transmission axis rotated around the optical axis 24 at 45 degrees with respect to an axis perpendicular to the optical axis 24, e.g., rotated around the Z-axis (into or out of the page). The transmissive polarizer 34 is configured to receive and transmit the first, back-side polarized light and the second, back-side polarized light.

In this last embodiment, unlike the broadband reflective coatings in previous embodiments, the forward-facing surfaces 33AF and 33BF of the LRO 32 may be coated or covered with a wire grid or polarizer films. In one example, on the first, front-side surface 33AF, the wire grid polarization film is oriented with its transmission axis aligned to the Y-axis. In this orientation, the first, front side 33AF has a polarization film (not labeled) that reflects horizontally polarized light and transmits vertically polarized light. Given that light 22 from the scene 20 is randomly polarized, 50% of the light 22 striking the first, front-side surface 33AF (25% of the total incident light 22) will reflect “upwards” along the +Y axis and strike the first sensor 40A, polarized horizontally. Similarly, 50% of the light 22 transmitted through the first, front side 33AF of the LRO 32 (25% of the total incident light 22) will continue towards the third sensor 40C in a vertically polarized state.

Also with this embodiment, on the second, front side 33BF, the wire grid polarization film is oriented with its transmission axis aligned to the X-axis. In this orientation, the polarization film on the second, front side 33BF, reflects vertically polarized light toward the second sensor 40B and transmits horizontally polarized light towards the third sensor 40C. Given that light 22 from the scene 20 is randomly polarized, 50% of the light 22 striking the second, front side 33BF (or 25% of the total incident light 22) will reflect “downwards” along the −Y axis and strike the second sensor 40B in a vertically polarized state. Similarly, 50% of the light transmitted through the second, front side 33BF of the LRO 32 (25% of the total incident light 22) will continue towards the third sensor 40C in a horizontally polarized state.

Before striking the third sensor 40C, light transmitted through the first, front side 33AF and the second, front side 33BF of the LRO 32 passes through a transmissive polarizer 34 with its transmission axis rotated around the optical axis 24 at 45 degrees with respect to an axis perpendicular to the optical axis 24, e.g., the Z-axis. In both cases, the amplitude of the light transmitted through the transmissive polarizer 34 is described by Malus' Law: I=I₀cos²(θ). Here, I₀ is the intensity of the incident light and θ is the difference in angle between the incident polarization and the angle of the transmission axis of the linear polarizer.

In the current configuration, θ is the same for light transmitted through the first, front-side surface 33AF and the second, front side 33BF of the LRO 32 (θ=45°). Additionally, the intensity of the light 22 transmitted through the first, front-side surface 33AF of the LRO 32 (25% of the total incident light 22) is equal to the intensity of light 22 transmitted through the second, front side 33BF of the LRO 32. That is, I₀ is the same for light 22 traveling both above and below the optical axis 24. In turn, the intensity of light passing through the top and bottom portions of the transmissive polarizer 34 are also equal: I=I₀cos²(θ)=0.25·cos²(45°)=0.25·0.50=0.125 of the total incident light 22. Physically, this means that 12.5% of the total incident light 22 is transmitted through the top portion of the transmissive polarizer 34, and 12.5% of the total incident light 22 is transmitted through the bottom portion of the transmissive polarizer 34. Since the total amount of light collected by the third sensor 40C is the sum of all light striking the sensor 40C, this is calculated to be 0.125 2, or 25% of the total light 22 entering the camera 106. Interestingly, this is the same amount of light collected by both the first and second sensors, 40A and 40B.

In this configuration, the aperture stop exploitation camera 106 is able to capture three independent images. While each image shares the same overall amplitude, each image captures a unique polarization state. Specifically, a first image 28A captures a horizontally polarized image, a second image 28B captures a vertically polarized image, and a third image 28C captures a 45-degree polarized image.

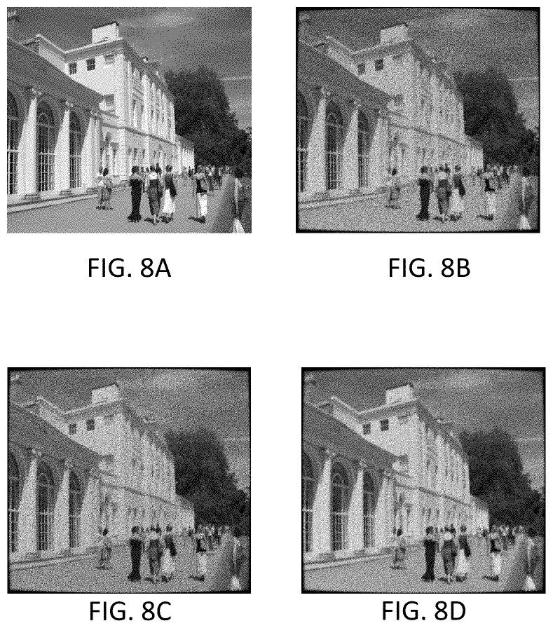

FIGS. 4, 5, and 6 illustrate simulated ray traces through embodiments of the aperture stop exploitation cameras 100-106. Also, FIGS. 8A-8D illustrate simulated image results of the aperture stop exploitation camera 100-104. FIG. 8A is an input image, FIGS. 8B and 8C are images reflected from an LRO 32 according to embodiments of the aperture stop exploitation cameras 100-104. Also, FIG. 8D is a transmitted image from an LRO 32 in the aperture stop exploitation cameras 100-104.

Numerical validation of the aperture stop exploitation camera 100-106 was performed with Zemax OpticStudio. As illustrated in FIGS. 4, 5, and 6, the simulated ray trace 22 validates the unique features of placing the LRO 32 at the aperture stop 26. By placing the (apex 32A of) LRO 32 at this location along the optical axis 24, the LRO 32 only relies on a simple coating, grating, or polarizer to produce three spatially independent images 28A, 28B, and 28C without the need for refraction or polarization splitting techniques currently seen in the literature.

Removing the rear lens array significantly decreases the weight and size of the aperture stop exploitation camera 100, but it may also degrade the quality of each image. To compensate, the geometry of the front lens system 30 was optimized to reduce the spot size on the third detector 40C using the “Hammer Current” optimization routine. Since no significant field distortions are introduced by the LRO 32 surfaces 33AF and 33BF, and since the distance between the reflected surfaces 33AF and 33BF of the LRO 32 and first 40A and second 40B sensors is similar to the distance between the LRO 32 and the third sensor 40C, the optimization was considered valid for the reflected images 28A and 28B as well. During the optimization, only the surface radii and lens materials were varied. The resulting reflected 28A, 28B and transmitted 28C images are illustrated in FIGS. 8B, 8C, and 8D, and the lens parameters are listed in Table 1. Lens units are in millimeters, the source is unpolarized and defined at blue, green, and red wavelengths (0.460, 0.588, and 0.656 μm, respectively). The resulting merit function value was 0.034.

TABLE 1
Optimized Parameter of the Front Lens Array 30

| Surface | Radius | Thickness | Material |
|---|---|---|---|
| 30A | −14.424 | 8.747 | LASF35 |
| 30B | −19.588 | 0.500 | LASF35 |
| 30C | 30.611 | 7.000 | P-SF68 |
| 30D | 13.413 | 3.777 | N-LASF31A |
| 26 | −306.688 | 3.000 | N-LASF31A |

Following the optimization, the reflected 28A, 28B and transmitted 28C images were simulated, as illustrated in FIGS. 8B, 8C, and 8D. Within the simulation, the apex 32A of the LRO 32 is defined by a single edge stretched between two nodes along the X-axis. In terms of ray tracing, this means the on-axis chief ray of the image simulation routine encounters a numerical discontinuity and cannot be traced to either detector used to capture the reflected images 28A or 28B. To get around this issue, the LRO 32 can be moved slightly (−0.1 mm) along the Y axis, displacing the singularity away from the optical axis 24. In this case, simulated images are produced, but the layout is inaccurate due to the off-axis nature of the LRO 32.

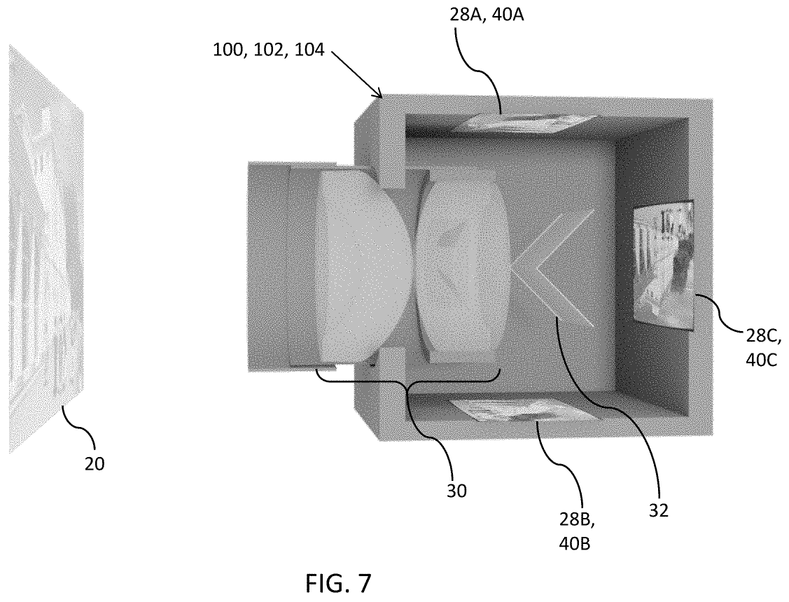

Instead, the Geometric Bitmap Analysis option was used to simulate images on each detector 40A, 40B, and 40C, enabling the LRO 32 to be placed along the optical axis 24. Although the routine ignores diffraction, it is based strictly on geometrical ray tracing. The simulated images for the first 40A, second 40B, and third 40C detector are illustrated in in FIGS. 8B, 8C, and 8D, respectively. In each image, the detector is defined as an 8800×7200 array of pixels, each pixel 1.75 μm on a side, and one thousand rays traced to each pixel. The proposed camera systems 101, 102, and 104 are illustrated in FIG. 7, scaled to the dimensions of the ray trace.

Subsequent aberration analysis was performed to determine the largest sources of error within the current aperture stop exploitation camera 100 configuration. Due to model inconsistencies caused by the interaction of the chief ray with the apex 32A of the LRO 32, however, aberration analysis can only be done on the back-side image 28C. Although optimization could be performed by approximating the LRO 32 with a planar (non-V-shaped) mirror tilted at 45 degrees with respect to the optical axis 24, it is assumed that the optimization of the transmitted image 28C is also valid for the top 28A and bottom 28B reflected images since there are no significant field distortions caused by the surfaces 33AF, 33BF of the LRO 32. While all seven aberration types (spherical aberration, coma, astigmatism, field curvature, distortion, axial color, and lateral color) are present at each lens surface, the summation of all the aberrations seen in the resulting images is highly dominated by spherical aberration. By comparison, the magnitude of the spherical aberration (0.32 mm) is roughly three times the magnitude of the second-largest aberration, distortion (−0.10 mm) at 588 nm wavelength.

Embodiments of the present disclosure provide a novel and intuitive way to simultaneously increase a camera system's capabilities while decreasing its size and weight. However, implementing this solution is not without cost since significant changes to the hardware and software infrastructure will likely drive an increase in overall price.

In addition to the cost of two new sensors (40A and 40B) and their physical mounts inside the aperture stop exploitation cameras 100-106, each sensor will require power from the electrical system, storage space in onboard memory, and processing resources to demosaic images in real-time. Similarly, the custom lenses will require time and resources to fabricate, a mechanical holder to support the lenses, and a lens mount to attach the lens system to the camera body. Much like the lenses, the LRO 32 will also require fabrication, thin-film coating, and mounting hardware to support its position within the aperture stop exploitation cameras 100-106.

Furthermore, if the LRO 32 mounting hardware is designed to be removable, the LRO 32 can be swapped out quickly during experiments, further increasing the flexibility of the cameras 100-106. On one hand, this is an enormous benefit—exchanging the LRO 32 in cameras 100-106 during an experiment enables the cameras 100-106 to quickly capture three images for each unique LRO component. On the other hand, each sensor 40A, 40B, and 40C needs to be able to independently change its ISO rating and shutter speed to accommodate for large variations in scene brightness. The third sensor variable, aperture setting, is shared across all three sensors 40A, 40B, and 40C due to the relative position of the LRO 32 with respect to the aperture stop 26. Finally, light 22 collected by the calibrated sensors 40A, 40B, and 40C would require pre-processing to convert the discrete pixel values into images and subsequently store them in a useful format such as PNG or JPEG.

With all this in mind, the three-fold increase in sensor surface area makes the cameras 100-106 well suited for a wide variety of applications, particularly when the forward LRO surfaces 33AF and 33BF are coated with minimally polarizing reflectivity coatings. Two such examples are briefly discussed below.

The first situation concerns highly complex and energetic events such as explosive detonations. In this case, the cameras 100—104 are capable of fully and simultaneously characterizing the spectral signature, structure, and emission of the fireball using commercially available detectors. While dynamic range could be obtained using a variable neutral density clip filter, high-density spectral information could be recorded using a XNiteCanon5DMK4-HS detector. Meanwhile, spectral emission characteristics need only use an imaging detector specific to the infrared.

As a second application, the cameras 100-104 are capable of removing limitations faced by other sophisticated imaging systems. In situations when color polarization filters are used as divided apertures, the data collection and post-processing are inherently limited by the number of spectral bands on the on-chip color filters—for a single three-color detector, the system is limited to capturing nine spectral bands. Alternatively, cameras 100-104 could utilize three separate image sensors 40A, 40B, and 40C, each with three unique color bands and covered with a custom color polarization filter. In this configuration, the maximum color band limitation is increased three-fold to twenty-seven spectral bands, which is more than adequate for multi-spectral index analysis of natural and explosive materials.

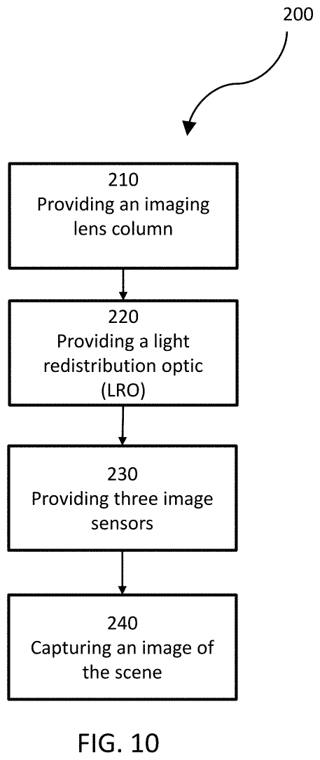

FIG. 10 illustrates an example method 200 of capturing an image of a scene according to embodiments of the present disclosure. In one embodiment, the method comprises providing 210 an imaging lens column positioned along an optical axis and configured to transmit light from a scene from a single viewpoint and through the aperture stop. The method further comprises providing 220 a light redistribution optic (LRO) that is a thin V-shape. The LRO has an apex centered along the optical axis with the apex pointing towards the imaging lens column. The LRO is positioned at the aperture stop and has two planar sides with each side angled 45 degrees with respect to the optical axis. Each side of the LRO is configured to reflect and transmit the light transmitted from the imaging lens column into three independent, spatially separate images. Each image retains all the spectral, polarimetric, and relative intensity information of the light from the scene.

The method further comprises providing 230 three image sensors, each image sensor positioned to receive one of the three independent, spatially separate images. Finally, the method comprises capturing 240 an image of the scene from each of the three image sensors.

The present invention may be embodied in other specific forms without departing from its spirit or essential characteristics. The described embodiments are to be considered in all respects only as illustrative, and not restrictive. All changes which come within the meaning and range of equivalency of the foregoing description are to be embraced within the scope of the invention.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art and are also intended to be encompassed by the following claims.

I claim:

1. An aperture stop exploitation camera, comprising:
an imaging lens column positioned along an optical axis and configured to transmit light from a scene from a single viewpoint and converge the light as it passes through the aperture stop;
a light redistribution optic (LRO) that is a thin V-shape having an apex, the LRO centered along the optical axis with the apex pointing towards the imaging lens column and positioned at the aperture stop, the LRO having two planar sides with each side angled 45 degrees with respect to the optical axis and each side configured to reflect and transmit the light transmitted from the imaging lens column into three independent, spatially separate images, with each image retaining all the spectral, polarimetric, and relative intensity information of the light from the scene; and
three image sensors, each image sensor positioned to receive one of the three independent, spatially separate images.

2. The aperture stop exploitation camera of claim 1, wherein the width and height of the LRO is smaller than a diameter of a largest lens in the imaging lens column.

3. The aperture stop exploitation camera of claim 1, wherein:
a first of the three independent, spatially separate images is reflected from the LRO onto a first of the three image sensors;
a second of the three independent, spatially separate images is reflected from the LRO onto a second of the three image sensors;
a third of the three independent, spatially separate images is transmitted through the LRO onto a third of the three image sensors; and
the first, second, and third of the three independent, spatially separate images each contain a full view of the scene.

4. The aperture stop exploitation camera of claim 3, wherein:
the thin V-shape has a front side and a back side, the front side faces the imaging lens column and the back side faces away from the imaging lens column;
a first, front side of the two planar sides is coated with a broadband non-polarizing 50% reflective coating (R_{c}=50%), the first, front side reflecting 25% of the light from the scene to the first of the three image sensors;
a first, back side, being opposite the first, front side, is coated with a broadband anti-reflection coating, the first, back side transmitting 25% of the light from the scene to the third of the three image sensors;
a second, front side of the two planar sides is coated with a broadband non-polarizing 50% reflective coating (R_{c}=50%), the second, front side reflecting 25% of the light from the scene to the second of the three image sensors;
a second, back side, being opposite the second, front side, is coated with a broadband anti-reflection coating, the second, back side transmitting 25% of the light from the scene to the third of the three image sensors; and
the first and second of the three image sensors each receiving 25% of the light from the scene; and
the third of the three image sensors receiving 50% of the light from the scene.

5. The aperture stop exploitation camera of claim 3, wherein:
the thin V-shape has a front side and a back side;
a first, front side of the two planar sides is coated with a broadband non-polarizing 66.67% reflective coating (R_{c}=66.67%), the first, front side reflecting 33.33% of the light from the scene to the first of the three image sensors;
a first, back side, being opposite the first, front side, is coated with a broadband anti-reflection coating, the first, back side of the two planar sides transmitting 16.67% of the light from the scene to the third of the three image sensors;
a second, front side of the two planar sides is coated with a broadband non-polarizing 66.67% reflective coating (R_{c}=66.67%), the second, front side reflecting 33.33% of the light from the scene to the second of the three image sensors;
a second, back side, being opposite the second, front side, is coated with a broadband anti-reflection coating, the second, back side of the two planar sides transmitting 16.67% of the light from the scene to the third of the three image sensors; and
the first, second, and third of the three image sensors each receiving 33.33% of the light from the scene.

6. The aperture stop exploitation camera of claim 3, wherein:
the thin V-shape has a front side and a back side, the front side faces the imaging lens column and the back side faces away from the imaging lens column;
a first, front side of the two planar sides is configured to reflect ultra-violet (UV) light, the front side reflecting UV light from the scene to the first of the three image sensors;
a second, front-side of the two planar sides is configured to reflect infrared (IR) light, the second, front-side reflecting IR light from the scene to the second of the three image sensors;
a first, back-side, being opposite the first, front side, and a second, back side, being opposite the second, front side, are both configured to transmit visible light from the scene to the third of the three image sensors;
the first of the three image sensors receives UV light from the scene, the first of the three imaging sensors being a UV sensor;
the second of the three image sensors receives IR light from the scene, the second of the three imaging sensors being an IR sensor; and
the third of the three image sensors receives visible light from the scene, the third of the three imaging sensors being a visible-light sensor.

7. The aperture stop exploitation camera of claim 3, wherein:
the thin V-shape has a front side and a back side, the front side faces the imaging lens column and the back side faces away from the imaging lens column;
a first, front side of the two planar sides is configured to reflect horizontally polarized light, the first, front side reflecting a first, front-side polarized light to the first of the three image sensors, the first, front-side polarized light being horizontally polarized;
a first, back side, being opposite the first, front side, is configured to transmit vertically polarized light, the first, back side transmitting a first, back-side polarized light towards the third of the three image sensors, the first, back-side polarized light being vertically polarized;
a second, front side of the two planar sides is configured to reflect vertically polarized light, the second, front side reflecting a second, front-side polarized light from the scene to the second of the three image sensors, the second, front-side polarized light being vertically polarized;
a second, back side, being opposite the second, front side, is configured to transmit horizontally polarized light, the second, back side of the two planar sides transmitting a second, back-side polarized light from the scene towards the third of the three image sensors, the second, back-side polarized light being horizontally polarized;
and, the aperture stop exploitation camera further comprises a transmissive polarizer with its transmission axis rotated around the optical axis at 45 degrees with respect to an axis perpendicular to the optical axis, the transmissive polarizer configured to receive and transmit the first, back-side polarized light and the second, back-side polarized light.

8. A method of capturing an image of a scene, the method comprising:
providing an imaging lens column positioned along an optical axis and configured to transmit light from a scene from a single viewpoint and through an aperture stop;
providing a light redistribution optic (LRO) that is a thin V-shape having an apex, the LRO centered along the optical axis with the apex pointing towards the imaging lens column and positioned at the aperture stop, the LRO having two planar sides with each side angled 45 degrees with respect to the optical axis and each side configured to reflect and transmit the light transmitted from the imaging lens column into three independent, spatially separate images, with each image retaining all the spectral, polarimetric, and relative intensity information of the light from the scene;
providing three image sensors, each image sensor positioned to receive one of the three independent, spatially separate images; and
capturing an image of the scene from each of the three image sensors.

9. The method of claim 8, further comprising providing an LRO wherein the width and height of the LRO is smaller than a diameter of a largest lens in the imaging lens column.

10. The method of claim 8, wherein:
a first of the three independent, spatially separate images is reflected from the LRO onto a first of the three image sensors;
a second of the three independent, spatially separate images is reflected from the LRO onto a second of the three image sensors;
a third of the three independent, spatially separate images is transmitted through the LRO onto a third of the three image sensors; and
the first, second, and third of the three independent, spatially separate images each contain a full view of the scene.

11. The method of claim 10, wherein:
the thin V-shape has a front side and a back side, the front side faces the imaging lens column and the back side faces away from the imaging lens column;
a first, front side of the two planar sides is coated with a broadband non-polarizing 50% reflective coating (R_{c}=50%), the first, front side reflecting 25% of the light from the scene to the first of the three image sensors;
a first, back side, being opposite the first, front side, is coated with a broadband anti-reflection coating, the first, back side transmitting 25% of the light from the scene to the third of the three image sensors;
a second, front side of the two planar sides is coated with a broadband non-polarizing 50% reflective coating (R_{c}=50%), the second, front side reflecting 25% of the light from the scene to the second of the three image sensors;
a second, back side, being opposite the second, front side, is coated with a broadband anti-reflection coating, the second, back side transmitting 25% of the light from the scene to the third of the three image sensors; and
the first and second of the three image sensors each receiving 25% of the light from the scene; and
the third of the three image sensors receiving 50% of the light transmitted from the scene.

12. The method of claim 10, wherein:
the thin V-shape has a front side and a back side;
a first, front-side of the two planar sides is coated with a broadband non-polarizing 66.67% reflective coating (R_{c}=66.67%), the first, front-side reflecting 33.33% of the light from the scene to the first of the three image sensors;
a first, back-side, being opposite the first, front side, is coated with a broadband anti-reflection coating, the first, back-side transmitting 16.67% of the light from the scene to the third of the three image sensors;
a second, front-side of the two planar sides is coated with a broadband non-polarizing 66.67% reflective coating (R_{c}=66.67%), the second, front-side reflecting 33.33% of the light from the scene to the second of the three image sensors;
a second, back-side, being opposite the second, front side, is coated with a broadband anti-reflection coating, the second, back-side transmitting 16.67% of the light from the scene to the third of the three image sensors; and
the first of the three image sensors receiving 33.33% of the light from the scene;
the second of the three image sensors receiving 33.33% of the light from the scene; and
the third of the three image sensors receiving 33.33% of the light from the scene.

13. The method of claim 10, wherein:
the thin V-shape has a front side and a back side, the front side faces the imaging lens column and the back side faces away from the imaging lens column;
a first, front side of the two planar sides is configured to reflect ultra-violet (UV) light, the front side reflecting UV light from the scene to the first of the three image sensors;
a second, front side of the two planar sides is configured to reflect infrared (IR) light, the second, front side reflecting IR light from the scene to the second of the three image sensors;
a first, back side, being opposite the first, front side, and a second, back side, being opposite the second, front side, are both configured to transmit visible light from the scene to the third of the three image sensors;
the first of the three image sensors receives UV light from the scene, the first of the three imaging sensors being a UV sensor;
the second of the three image sensors receives IR light from the scene, the second of the three imaging sensors being an IR sensor; and
the third of the three image sensors receives visible light from the scene, the third of the three imaging sensors being a visible-light sensor.

14. The method of claim 10, wherein:
the thin V-shape has a front side and a back side, the front side faces the imaging lens column and the back side faces away from the imaging lens column;
a first, front side of the two planar sides is configured to reflect horizontally polarized light, the first, front side reflecting a first, front-side polarized light to the first of the three image sensors, the first, front-side polarized light being horizontally polarized;
a first, back side, being opposite the first, front side, is configured to transmit vertically polarized light, the first, back side transmitting a first, back-side polarized light towards the third of the three image sensors, the first, back-side polarized light being vertically polarized;
a second, front side of the two planar sides is configured to reflect vertically polarized light, the second, front side reflecting a second, front-side polarized light from the scene to the second of the three image sensors, the second, front-side polarized light being vertically polarized;
a second, back side, being opposite the second, front side, is configured to transmit horizontally polarized light, the second, back side of the two planar sides transmitting a second, back-side polarized light from the scene towards the third of the three image sensors, the second, back-side polarized light being horizontally polarized; and,
the aperture stop exploitation camera further comprises a transmissive polarizer with its transmission axis rotated around the optical axis at 45 degrees with respect to an axis perpendicular to the optical axis, the transmissive polarizer configured to receive and transmit the first, back-side polarized light and the second, back-side polarized light.
